(19) United States
(12) Patent Application Publication
(10) Pub. No.: US 2023/0347915 A1
(43) Pub. Date: Nov. 2, 2023

(54) Method and System for Predicting the Functional Quality of a Driver Assistance Function

(71) Applicant: Bayerische Motoren Werke Aktiengesellschaft, Muenchen (DE)

(72) Inventor: Thomas HELMER, Muenchen (DE)

(21) Appl. No.: 18/017,314

(22) PCT Filed: Jul. 16, 2021
(86) PCT No.: PCT/EP2021/069986

§ 371 Date: Jan. 20, 2023

(30) Foreign Application Priority Data
Jul. 24, 2020 (DE) 10 2020 119 625.3

(51) Int. Cl. B60W 50/04; B60W 50/14; G01C 21/36

(52) U.S. Cl. CPC B60W 50/04; B60W 50/14; G01C 21/3697; B60W 2050/146; B60W 2556/40; B60W 2556/45

(57) ABSTRACT

A method for predicting the functional quality of a driver assistance function includes detecting information by a first vehicle characterizing the functional quality of a driver assistance function or being relevant to the functional quality of the driver assistance function, determining the functional quality of the driver assistance function for a second vehicle which is identical to the first vehicle or differs therefrom on the basis of the detected information predicting the functional quality for a route section, and outputting information relating to the predicted functional quality by an output device in a manner perceivable to a vehicle occupant of the second vehicle. In the process, the information is detected by accessing a control system of the first vehicle and/or the predicted functional quality is determined by accessing data which has been provided by a control system of the second vehicle.

### BACKGROUND AND SUMMARY

The invention relates to a method for predicting the functional quality of a driver assistance function.

Different driver assistance systems (DAS) which can increase safety and/or comfort for a driver or vehicle occupant are known from the prior art. Driver assistance systems can take over specific driving tasks or even autonomously control the vehicle e.g. in partly automated driving (PAD), highly automated driving (HAD) or fully automated driving (FAD).

A lane assistant, for example, can be configured to keep the vehicle between road markings. The markings can be scanned and detected automatically e.g. by a camera. Other driver assistance systems do not intervene directly in the driving of the vehicle, but merely provide specific signaling, such as e.g. warning signals, as a result of which safe driving of the vehicle is simplified for the driver.

Examples of driver assistance systems which automatically intervene in the driving of the vehicle include longitudinal driving assistance systems, transverse driving assistance systems and assistance systems with combined longitudinal and transverse driving. Automatic speed limitation, for example, automatic speed control (e.g. referred to as Dynamic Cruise Control— DCC— for vehicles of the BMW Group) or Adaptive Cruise Control or Active Cruise Control— ACC— can be mentioned as known longitudinal driving assistance systems. Transverse driving assistance systems, longitudinal driving assistance systems or combined longitudinal and transverse driving assistance systems can implement e.g. a hands-off functionality or feet-off functionality which relieves the driver of specific steering or pedal actuation tasks.

Different operating modes which sometimes also permit an “override” by the driver are known for driving assistance systems of this type. It can be provided, for example, that the driver can override an ACC function with the gas pedal and can thus temporarily take over the longitudinal driving himself. If the driver then takes his foot off the gas pedal once more, the ACC function resumes control on the basis of a set speed or a vehicle in front.

Parking maneuver assistants and automatic reversing assistants are further known, wherein the latter enable a specific section of an approach route (travelled at low speed) to be stored and automatically reversed along on request.

Examples of driver assistance systems which automatically provide a warning function in specific situations (and, in some instances, can additionally comprise a steering intervention and/or intervention in longitudinal driving if necessary) are lane change assistants and assistance systems for front collision warning, pedestrian warning, side collision warning, cross-traffic warning or lane departure warning.

In the present document, a driver assistance system is generally understood to mean a system which, through implementation in software and/or hardware, is designed to output signaling relevant to the driver or vehicle occupant, e.g. from a safety or comfort perspective, such as e.g. a warning signal, on the basis of data determined by one or more sensors, and/or to intervene in the driving of the vehicle or to take complete control—permanently or at least temporarily—of the driving of the vehicle.

Driver assistance systems are normally deactivated when certain conditions for their operation are no longer satisfied. These operating conditions, which must prevail for safe and reliable use of a DAS, can relate, for example, to a current vehicle environment and, in particular, a road layout. A steering and lane-keeping assistant, for example, is thus deactivated as soon as too much steering torque is required to maintain the trajectory on a sharp bend. This occurs frequently and reproducibly, for example, on highway onramps. Further situations which can typically result in a deactivation of a DAS are driving across intersections, driving around traffic circles, etc.

A take-over request (TOR) to the driver is normally triggered before the deactivation (sometimes also referred to as “abort”) of a DAS. This means that an alert is output to the driver in a manner perceivable to the driver (i.e., for example, audibly and/or visually) indicating that he must soon manually take over control of the vehicle at least partially in order to thus prepare a safe deactivation of the driver assistance system or a specific driver assistance function of the DAS.

The peace of mind of a driver generally depends on the availability and operational performance of the DAS of his vehicle. The driver therefore tends to feel uncomfortable if a DAS is frequently aborted, particularly if he is surprised before a deactivation of a DAS so that, for example, he suddenly and possibly very energetically has to intervene manually in the steering and/or in the longitudinal driving of the vehicle.

An object of the present disclosure is to provide a method and a system which at least partially overcome the disadvantages in the prior art.

The object is achieved by a method and a system as disclosed herein. Advantageous embodiments are also disclosed herein. It should be noted that additional features of a patent claim dependent on an independent patent claim can form a separate invention which is independent from the combination of all features of the independent patent claim and can constitute the subject-matter of an independent patent claim, a divisional application or subsequent application without the features of the independent patent claim or only in combination with a subset of the features of the independent patent claim. This similarly applies to technical teachings set out in the description which can form an invention which is independent from the features of the independent patent claims.

A first aspect of the present disclosure relates to a method for predicting the functional quality of a driver assistance function.

A first step of the method according to the present disclosure comprises detecting information by means of a first vehicle, said information characterizing the functional quality of a driver assistance function or being relevant to the functional quality of the driver assistance function.

In the context of the present document, a vehicle is to be understood to mean essentially any vehicle type with which persons and/or goods can be transported. Possible examples thereof are: motor vehicles, trucks, land vehicles, buses, drivers' cabs, cable cars, elevator cabs, rail vehicles, watercraft (e.g. ships, boats, submarines, diving bells, hovercraft, hydrofoils), aircraft (airplanes, helicopters, ground effect vehicles, airships, balloons).

In particular, the vehicle can be a motor vehicle. A motor vehicle in this sense is a land vehicle which is moved by machine power without being bound to railroad tracks. A motor vehicle in this sense can be designed e.g. as an automobile, a motorcycle or a traction unit.

The first vehicle is preferably equipped with a driver assistance function.

However, a plurality of such first vehicles, preferably an entire fleet, can be provided and can be involved in the method described here.

The detected information can comprise, for example, empirical data relating to the functional quality of the driver assistance function experienced by means of the first vehicle. This can relate e.g. to an operational performance or availability of the driver assistance function according to a situation-dependent condition, such as e.g. the weather, ambient brightness, a possible “dazzling” of sensors, a bend in the road or a driving speed. The detected information can also comprise, in particular, data from an environment sensor system of the first vehicle (e.g. weather data or speed data) and/or from an environment model used by the first vehicle. In other words, the first information can directly or indirectly provide evidence of the situation-dependent functional quality, in particular the availability, of the driver assistance function. The first information can further comprise vehicle data (e.g. relating to a hardware and/or software version) of the first vehicle.

A further step comprises determining the functional quality of the driver assistance function predicted for a specific route section for a second vehicle on the basis of the detected information and using a computing device. The second vehicle can be identical to the first vehicle (i.e. it can be the first vehicle) or can differ from said first vehicle, i.e. a vehicle other than the first vehicle.

A further step comprises outputting information relating to the predicted functional quality by an output device in a manner which is perceivable to a vehicle occupant of the second vehicle. This information can be output, for example, by a visual display and/or by an audible message.

The information relating to the predicted functional quality is preferably output by the graphically presented map which comprises the route section.

In one possible embodiment, the display device is arranged in the second vehicle or on the second vehicle. The display device can, for example, be a display screen provided in the cockpit or a projection arrangement, e.g. in the form of a touch screen or a head-up display. It can, for example, be a display device of an on-board computer of the second vehicle, wherein, in addition to the usage data, other information, such as e.g. the current driving speed, the current engine speed or navigation instructions can also be displayed if necessary by the display device. It can be provided, for example, that the driver can retrieve the visualized information via a corresponding menu within a portal implemented by software and/or in an app and/or in a widget and/or in an applet.

Alternatively or additionally, however, a display device removed from the second vehicle or removable from the second vehicle can be provided, e.g. in the form of a mobile device. In other words, information relating to the predicted functional quality can be displayed e.g. on a mobile device, such as e.g. a smartphone or notebook or by a desktop computer located outside the second vehicle. The driver can access the information, for example, via a special vehicle app from his mobile device or via a customer account of via a web portal. A mobile device or desktop computer can therefore serve as a (possibly additional) display device for the usage data.

The information relating to the predicted functional quality can comprise, in particular, a prediction indicating whether the driver assistance function will (probably) be available in the route section concerned. This offers the advantage for the driver of the second vehicle that he obtains a consistent picture of the functional availability and can comfortably adjust to it in advance. Furthermore, the driver can successively enhance his consistent picture of the functional quality by means of the method according to the present disclosure and can continue to increase his knowledge of it over time. Unpleasant surprises, e.g. due to a sudden deactivation of a driver assistance function, can thereby be avoided. The information can also comprise e.g. a positive recommendation, indicating that the driver assistance function will (probably) work particularly well in the route section concerned.

According to the method, it is provided that the information is detected by accessing a control system of the first vehicle, wherein, according to some embodiments, additional manual inputs can also be performed by the driver if necessary. The control system can, in particular, be a control system which controls the driver assistance function of the first vehicle. The term control system is intended to be understood here to include, for example, corresponding logical computing devices such as one or more microcontrollers or processors, but also, if necessary, an environment sensor system.

Alternatively or additionally to the feature according to which the information is detected by accessing a control system of the first vehicle, it is provided according to the present disclosure that the predicted functional quality is determined by accessing data which are provided by a control system of the second vehicle.

The predicted functional quality is preferably determined by taking account of information which relates to at least one element from the following list: a road layout in the route section, such as e.g. a bend in the road, as it appears e.g. according to digital map information and/or according to data captured by an environment sensor system of the second vehicle; a software version of the second vehicle (in particular of a control system of the second vehicle which is relevant to the driver assistance function); hardware of the second vehicle; an environment model which is provided by the control system of the second vehicle; information detected by an environment sensor system of the second vehicle, such as e.g. weather conditions, brightness, or glare. A planned speed, for example, and/or a speed limit which applies according to digital map information or according to a traffic sign in the route section can further be taken into account in determining the predicted functional quality.

In one advantageous embodiment, information relating to the predicted functional quality is provided to a control system of the second vehicle. In particular, the method can comprise (automatically) controlling the driver assistance function of the second vehicle on the basis of the predicted functional quality. Controlling the driver assistance function means a targeted influencing of the driver assistance function, such as e.g. an (if necessary partial) release, an (if necessary partial) deactivation, restriction or parameterization, wherein this can be performed, in particular, in a targeted manner in relation to the route section concerned.

According to the present disclosure, in line with the description given above, the method can further comprise automatically deactivating the driver assistance function of the second vehicle before driving along the route section if the determination has revealed that the functional quality is not sufficient (e.g. in terms of one or more predetermined criteria which relate e.g. to the safety or reliability of the driver assistance function).

According to one embodiment, the detected information is stored and processed in a backend distanced from the first vehicle and from the second vehicle. The backend can comprise e.g. one or more computing devices and one or more storage devices. It can be provided accordingly, for example, that the detected information is transmitted—preferably in anonymized form—to a backend server located outside the first vehicle and the second vehicle. The backend can be operated e.g. by the vehicle manufacturer. Increasing amounts of information, for example, which is relevant to the prediction of the functional quality of the driver assistance function and which, for example, is based on detected information of an entire vehicle fleet can be aggregated in the backend over time. A self-learning algorithm, for example, can enable an increasingly reliable prediction of the functional quality on this basis. A self-learning algorithm of this type can be e.g. conventionally deterministic and/or based on one or more neural networks.

According to a second aspect of the present disclosure, a system is proposed for predicting the functional quality of a driver assistance system. The system comprises a computing device which is configured to receive information which characterizes the functional quality of a driver assistance function or is relevant to the functional quality of the driver assistance function, wherein the information has been detected by means of a first vehicle, and to determine, on the basis of the detected information, the functional quality of the driver assistance function predicted for a route section for a second vehicle which is identical to the first vehicle or differs therefrom. The system further comprises an output device for outputting information relating to the predicted functional quality in a manner perceivable to a vehicle occupant of the second vehicle.

A method according to the first aspect of the present disclosure can be carried out, for example, by a system according to the second aspect of the present disclosure. Correspondingly, the descriptions relating to the method according to the present disclosure according to the first aspect of the present disclosure apply accordingly to the system according to the second aspect of the present disclosure also, and vice versa.

According to one embodiment, a system according to the present disclosure comprises a backend arranged outside the first vehicle and the second vehicle. The backend can comprise the computing device of the system. The backend can further comprise a storage device for storing the detected information and/or information derived therefrom, such as e.g. information relating to the predicted functional quality of the driver assistance function.

The system can further comprise a transmission device for transmitting the detected information from the first vehicle to the backend and/or a transmission device for transmitting information relating to the predicted functional quality from the backend to the second vehicle. The data transmission is preferably performed wirelessly (e.g. via mobile radio or Wi-Fi). A mobile radio interface, for example, according to the 3G, 4G or 5G mobile radio standard can thus be used in each case to transmit the information concerned from the first vehicle to the backend or from the backend to the second vehicle.

In line with the description above, some embodiments of a method according to the present disclosure or a system according to the present disclosure enable a self-learning prediction function for the functional quality of a driver assistance function. Data, for example, relating to function deactivations, along with the respective current positions, directions, speeds and accelerations and possibly further environmental parameters (e.g. weather, time, date, etc.) are collected in a backend from a vehicle fleet by means of wireless communication. A map with the spatial/temporal and further situation-related parameters not controllable by the driver assistance function is created e.g. continuously and in real time on the basis of this information. This takes place centrally in the backend and uses the input of the entire correspondingly equipped vehicle fleet. The function availability models learnt in this way can again be made available by means of wireless communication to each individual vehicle and, if necessary, can effect an early, convenient and transparent deactivation of the driver assistance function there. The automatic deactivation can even take place, for example, considerably in advance of a specific highway onramp if an abort has occurred in some vehicles of the fleet on the crest of the highway onramp. In this way, the drivers obtain a consistent picture of function availability and can comfortably adjust to it.

A further advantage is that the behavior of the vehicles can adapt dynamically to changes (e.g. in a road layout or even in the actual hardware or software version).

The method according to the present disclosure is usable in a multiplicity of driver assistance functions, such as e.g. steering and lane guidance assistants, ACC and parking assistance.

The present disclosure will now be explained in detail on the basis of exemplary embodiments and with reference to the attached drawings. The features and feature combinations mentioned in the description and/or shown in the drawings alone are usable not only in the respectively indicated combination, but also in other combinations or in isolation without departing the scope of the present disclosure.

### BRIEF DESCRIPTION OF THE DRAWINGS

FIG. 1 shows schematically and by way of example a system for predicting the functional quality of a driver assistance function.

FIG. 2 shows a schematic flow diagram of a method for predicting the functional quality of a driver assistance function according to one exemplary embodiment.

FIG. 3 shows a schematic flow diagram of a development of the method from FIG. 2.

### DETAILED DESCRIPTION

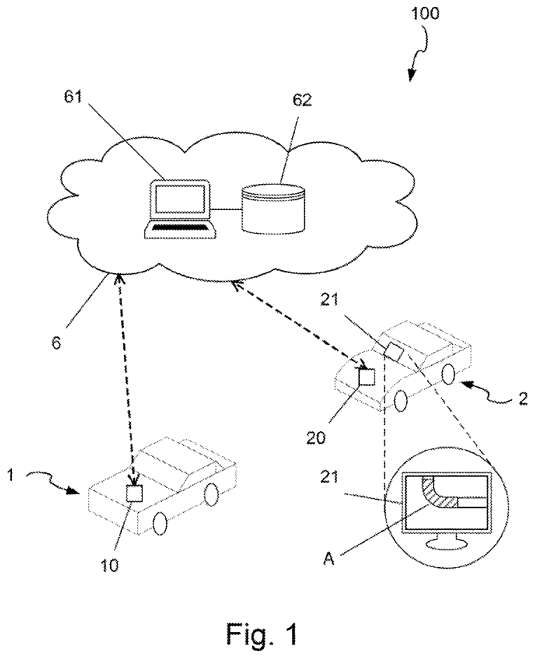

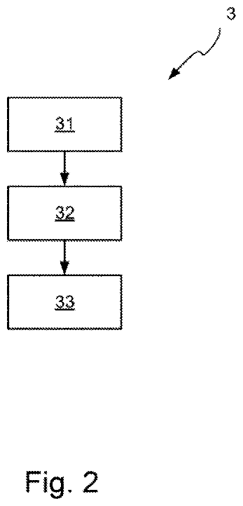

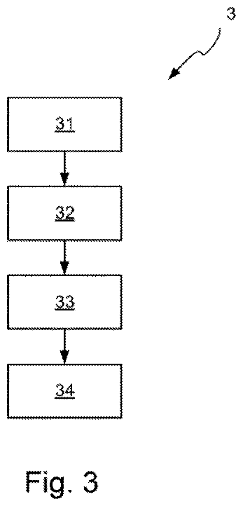

FIG. 1 refers to an example scenario with two vehicles 1, 2 in which a method 3 according to the present disclosure is carried out by a system 100 for predicting the functional quality of the driver assistance function. The present disclosure is explained below by way of example on the basis of this example scenario, wherein reference is made at the same time to method steps 31-34 according to FIGS. 2 and 3 which in each case show a schematic flow diagram of an exemplary embodiment of the method 3.

FIG. 1 shows a first vehicle 1 which is equipped with a driver assistance function, such as e.g. a steering and lane guidance assistant.

Information which characterizes the functional quality of the driver assistance function and/or which is relevant to the functional quality of the driver assistance function is detected during the journey by accessing a control system 10 of the driver assistance function of the first vehicle 1 (step 31 in FIGS. 2 and 3). The detected information comprises empirical data relating to the functional quality of the driver assistance function experienced by means of the first vehicle 1 and/or to conditions (e.g. relating to the weather) which are relevant to the functional quality.

It is detected, for example, whether the driver assistance function was available on a specific bend on which the first vehicle 1 drove at a specific time or whether it was deactivated fully or partially in or before the bend (i.e. was aborted, e.g. because the bend was too sharp for automatic transverse driving at the driven speed). In addition, the detected information can contain further parameters which relate e.g. to weather conditions, driving speed or a software version of the vehicle 1.

The detected information is transmitted by a mobile radio connection from the first vehicle 1 to a backend 6. The backend 6 comprises a computing device 61 and a storage device 62 which enable processing or storage of the detected information. The computing device 61 receives the information detected by the first vehicle 1. The storage device 62 can serve e.g. as a memory or buffer memory for detected information or for information subsequently derived therefrom.

In addition to the information detected by the first vehicle 1, many other vehicles (not shown) can also supply corresponding information to the backend 6. In other words, detected information from an entire vehicle fleet can be aggregated in the backend 6.

On the basis of the detected information, the computing device 61 in the backend 6 determines the functional quality of the driver assistance function predicted for a specific section A for a second vehicle 2 differing from the first vehicle 1 (step 32 in FIGS. 2 and 3). The route section A can, for example, be the above-mentioned bend on which the first vehicle 1 has driven. In particular, the route section A can be a route section along which the second vehicle 2 is about to drive according to a current route planning.

The information relating to the predicted functional quality of the driver assistance function determined in this way can comprise, in particular, a prediction indicating whether the driver assistance function will be available in the route section A. The computing device 61 can, for example, provide an increasingly reliable prediction of the situation-dependent availability of the driver assistance function over time by a self-learning algorithm on the basis of the information detected by the vehicle fleet.

The information relating to the predicted functional quality of the driver assistance function is transmitted by a mobile radio connection from the backend 6 to the second vehicle 2 and is output by an output device 21 to a vehicle occupant of the second vehicle 2 (step 33 in FIGS. 2 and 3).

In the present exemplary embodiment, the output device 21 comprises a display screen on which the route section A is graphically presented and is marked by shading. This marking can mean, for example, that the driver assistance function will not be available under the given conditions (e.g. current weather, driving speed and software version of the driver assistance function of the second vehicle 2) according to the prediction in the route section A. As a result, the driver of the second vehicle 2 is already aware in advance that the take-over request will be made before the route section A.

In addition, the information relating to the predicted functional quality can also be made available directly to a control system 20 of the driver assistance function of the second vehicle 2. In this case, according to one variant of the method which is shown schematically in FIG. 3, a further step 34 can be provided in which the driver assistance function of the second vehicle 2 is controlled on the basis of the predicted functional quality. This means e.g. that an automatic release, deactivation, restriction or parameterization of the driver assistance function can be performed by the control system 20 on the basis of the predicted functional quality. In particular, the driver assistance function of the second vehicle 2 can be deactivated automatically before driving along the route section A if the determination 32 has revealed that the predicted functional quality is not sufficient. If an abort of the driver assistance function in the area of the route section A is therefore to be expected in any case e.g. due to the predicted functional quality, an earlier automatic deactivation can be performed if necessary. An unpleasant surprise for the driver due to a sudden deactivation of the driver assistance function is thereby prevented.

The predicted functional quality can even be determined 32 by accessing (and taking account of) data which are provided by the control system 20 of the second vehicle 2. Such data can comprise e.g. information relating to a software version and/or a hardware version of the second vehicle 2. Such data can further comprise information relating to an environment model which is provided by the control system 20 of the second vehicle 2. Such data can further contain information which has been detected by an environment sensor system of the second vehicle (e.g. concerning weather, brightness, road layout, traffic signs, etc.).

In the exemplary embodiment described here, the second vehicle 2 is different from the first vehicle 1. In other exemplary embodiments, however, the second vehicle 2 can also be identical to the first vehicle 1. In such a case, the detected information can be stored and processed e.g. locally in the vehicle entirely without the involvement of a backend. The vehicle does not benefit from the acquired findings of other vehicles, but the vehicle can nevertheless collect increasingly reliable information relating to the predicted quality of the driver assistance function over time on the basis of its own detected data, which enhance the driving experience of the vehicle occupants. As far as the display and the further use of the information relating to the predicted functional quality are concerned, this embodiment variant does not differ from the embodiment variant with two different vehicles 1, 2, so that reference can be made in this respect to the description above.

1-10. (canceled)

11. A method for predicting a functional quality of a driver assistance function comprising:
detecting information by a first vehicle, said information characterizing the functional quality of a driver assistance function or being relevant to the functional quality of the driver assistance function;
determining the functional quality of the driver assistance function predicted for a specific route section on a basis of the detected information and using a computing device for a second vehicle that is identical to or different from the first vehicle; and
outputting information relating to the predicted functional quality by an output device in a manner perceivable to a vehicle occupant of the second vehicle,
wherein, at least one of:
the information is detected by accessing a control system of the first vehicle, and/or
the predicted functional quality is determined by accessing data which are provided by a control system of the second vehicle.

12. The method as claimed in claim 11, wherein the information relating to the predicted functional quality is output by a graphically presented map comprising the route section.

13. The method as claimed in claim 11, wherein the information relating to the predicted functional quality comprises a prediction indicating whether the driver assistance function will be available in the route section.

14. The method as claimed in claim 11, wherein the detected information is stored and processed in a backend system distanced from the first vehicle and the second vehicle.

15. The method as claimed in claim 11, wherein the detected data comprise empirical data relating to the functional quality of the driver assistance function experienced by the first vehicle.

16. The method as claimed in claim 11, wherein the functional quality is determined taking account of information which relates to at least one element from the following list:
a road layout in the route section;
a software version of the second vehicle;
hardware of the second vehicle;
an environment model which is provided by the control system of the second vehicle; and/or
information detected by means of an environment sensor system of the second vehicle.

17. The method as claimed in claim 11, wherein the information relating to the predicted functional quality is provided to a control system of the second vehicle.

18. The method as claimed in claim 11, further comprising:
controlling the driver assistance function of the second vehicle on a basis of the predicted functional quality.

19. The method as claimed in claim 11, further comprising:
automatically deactivating the driver assistance function of the second vehicle before driving along the route section in response to the determination revealing that the predicted functional quality is not sufficient.

20. A system for predicting a functional quality of a driver assistance function, comprising:
a computing device configured to:
receive information that characterizes the functional quality of a driver assistance function or is relevant to the functional quality of the driver assistance function, wherein the information has been detected by means of a first vehicle; and
determine, on a basis of the detected information, the functional quality of the driver assistance function predicted for a route section for a second vehicle which is identical to the first vehicle or differs therefrom.

21. The system as claimed in claim 29, wherein the output device comprises a display configured to output information relating to the predicted functional quality by a graphically presented map comprising the route section.

22. The system as claimed in claim 20, wherein the information relating to the predicted functional quality comprises a prediction indicating whether the driver assistance function will be available in the route section.

23. The system as claimed in claim 20, further comprising a backend system distanced from the first vehicle and the second vehicle, wherein the backend system is configured to store and process the detected information.

24. The system as claimed in claim 20, wherein the detected data comprise empirical data relating to the functional quality of the driver assistance function experienced by the first vehicle.

25. The system as claimed in claim 20, wherein the computing device is configured to determine the functional quality taking account of information which relates to at least one element from the following list:
a road layout in the route section;
a software version of the second vehicle;
hardware of the second vehicle;
an environment model which is provided by the control system of the second vehicle; and/or
information detected by means of an environment sensor system of the second vehicle.

26. The system as claimed in claim 20, wherein the computing device is configured to provide the information relating to the predicted functional quality to a control system of the second vehicle.

27. The system as claimed in claim 20, wherein the computing device is configured to control the driver assistance function of the second vehicle on a basis of the predicted functional quality.

28. The system as claimed in claim 20, wherein the computing device is configured to automatically deactivate the driver assistance function of the second vehicle before driving along the route section in response to the determination revealing that the predicted functional quality is not sufficient.

29. The system as claimed in claim 20, further comprising:
an output device configured to output information relating to the predicted functional quality in a manner perceivable to a vehicle occupant of the second vehicle.
